(19) United States
(12) Patent Application Publication
(10) Pub. No.: US 2012/0307504 A1
(43) Pub. Date: Dec. 6, 2012

(54) LAMPSHADE FOR AN LED LAMP

(76) Inventor: Min-Hwa CHOU, Tainan (TW)

(21) Appl. No.: 13/153,158

(22) Filed: Jun. 3, 2011

(51) Int. Cl. F21V 1/00

(52) U.S. Cl. 362/351

(57) ABSTRACT

A lampshade has a body and multiple light-concentrating units formed on the body. Each light-concentrating unit has a light input recess and a light output protrusion. The light input recess is defined in one of the side of the body and has an inner wall to define a holding space in the light input recess. The light output protrusion is formed on and protrudes from the other side of the body, corresponds to the light input recess and has a smooth outer wall. Accordingly, the light emitting from an LED lamp can be further concentrated with the curvatures of the inner walls of the light input recesses and the outer walls of the light output protrusions, such that the illumination of the light emitted from the LED lamp can be improved.

### BACKGROUND OF THE INVENTION

1. Field of the Invention

The present invention relates to a lampshade, and more particularly to a lampshade for an LED lamp to provide an enhanced light-concentrating effect.

2. Description of Related Art

An LED (light emitting diode) lamp substantially comprises a base, an LED module and a lampshade. The LED module is mounted on the base and has a circuit board and at least one LED element mounted on the circuit board. The lampshade is mounted on the base and around the LED module and comprises a top surface, a bottom surface and at least one concentrating recess. The at least one concentrating recess is defined in the bottom surface, and each concentrating recess has an annular inner wall mounted around a corresponding LED element of the LED module. The top surface of the lampshade is a flat surface without protrusions and serves as a light output surface.

With such an arrangement, the light emitting from the LED element pass through and is refracted by the annular inner wall of the concentrating recess and emits out from the flat light output surface. Because the light output surface of the conventional LED lampshade is flat, the light concentrating effect is not sufficient and the illumination of the conventional LED lamp is low.

To overcome the shortcomings, the present invention tends to provide a lampshade to mitigate or obviate the aforementioned problems.

### SUMMARY OF THE INVENTION

The main objective of the invention is to provide a lampshade for an LED lamp to provide an enhanced light-concentrating effect so as to improve the illumination of the light emitted from the LED lamp.

The lampshade has a body and multiple light-concentrating units formed on the body. Each light-concentrating unit has a light input recess and a light output protrusion. The light input recess is defined in one of the side of the body and has an inner wall to define a holding space in the light input recess. The light output protrusion is formed on and protrudes from the other side of the body, corresponds to the light input recess and has a smooth outer wall.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lampshade in accordance with the present invention;

FIG. 2 is a cross sectional side view of the lampshade in FIG. 1;

FIG. 3 is a perspective view of a second embodiment of a lampshade in accordance with the present invention;

FIG. 4 is a cross sectional side view of the lampshade in FIG. 3;

FIG. 5 is a cross sectional partial side view of a third embodiment of a lampshade in accordance with the present invention;

FIG. 6 is a cross sectional partial side view of a fourth embodiment of a lampshade in accordance with the present invention;

FIG. 7 is a cross sectional partial side view of a fifth embodiment of a lampshade in accordance with the present invention;

FIG. 8 is a cross sectional partial side view of a sixth embodiment of a lampshade in accordance with the present invention;

FIG. 9 is a cross sectional partial side view of a seventh embodiment of a lampshade in accordance with the present invention;

FIG. 10 is a cross sectional partial side view of an eighth embodiment of a lampshade in accordance with the present invention;

FIG. 11 is a cross sectional partial side view of a ninth embodiment of a lampshade in accordance with the present invention;

FIG. 12 is a cross sectional partial side view of a tenth embodiment of a lampshade in accordance with the present invention;

FIG. 13 is a cross sectional partial side view of an eleventh embodiment of a lampshade in accordance with the present invention;

FIG. 14 is a cross sectional partial side view of a twelfth embodiment of a lampshade in accordance with the present invention;

FIG. 15 is a cross sectional partial side view of a thirteenth embodiment of a lampshade in accordance with the present invention; and

FIG. 16 is a cross sectional partial side view of a fourteenth embodiment of a lampshade in accordance with the present invention.

### DETAILED DESCRIPTION OF PREFERRED EMBODIMENT

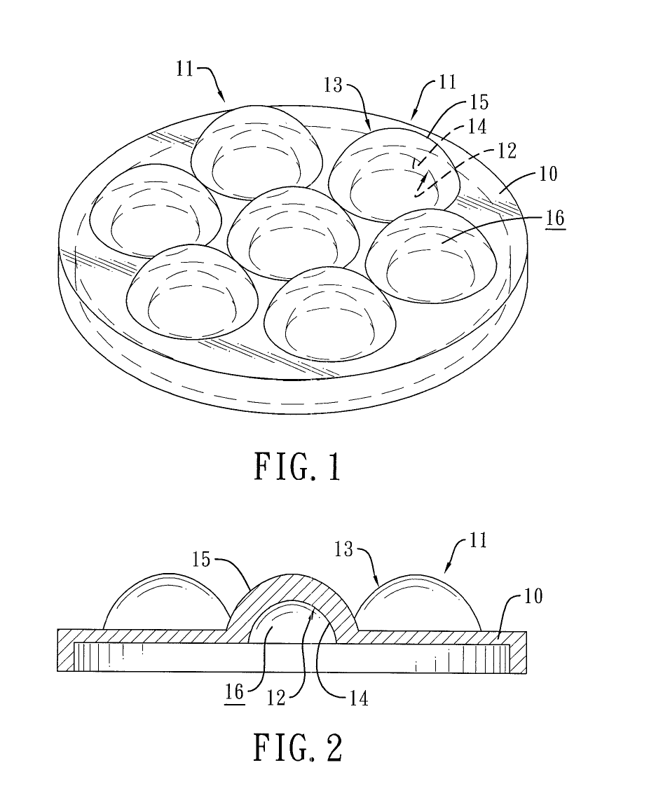

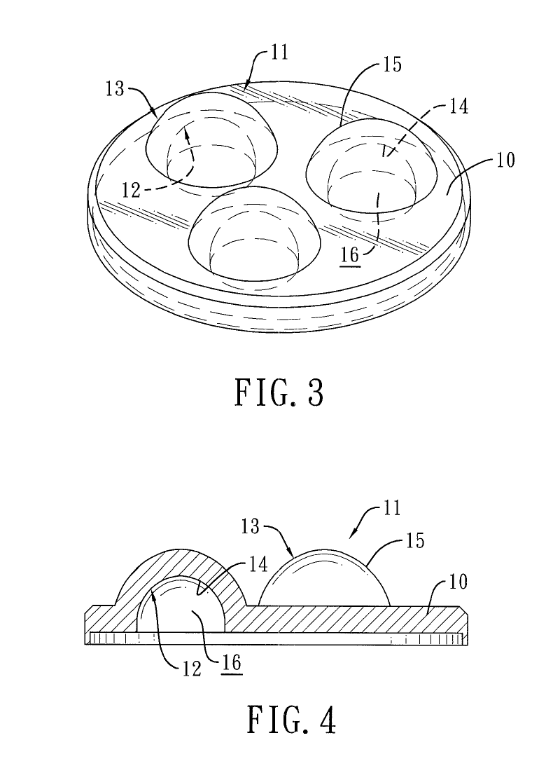

With reference to FIGS. 1 to 4, a lampshade for an LED lamp in accordance with the present invention comprises a body 10 and multiple light-concentrating units 11. The body 10 has two sides. The light-concentrating units 11 are formed on the body 10, and each light-concentrating unit 11 comprises a light input recess 12 and a light output protrusion 13. The light input recess 12 and the light output protrusion 13 are formed respectively on the sides of the body 10 and correspond to each other. The light input recess 12 is defined in one of the side of the body 10 and has an inner wall 14 to define a holding space 16 in the light input recess 12. The light output protrusion 13 is formed on and protrudes from the other side of the body 10, corresponds to the light input recess 12 and has a smooth outer wall 15. Preferably, three, seven or another possible number of light-concentrating units 11 may be implemented. In addition, the number of the light-concentrating units 11 may be changed to fit with different needs of use or design demand.

In addition, the inner wall 14 of the light input recess 12 of each light-concentrating unit 11 has at least one curvature for light input. The outer wall 15 of the light output protrusion 13 of each light-concentrating unit 11 has at least one curvature for light output. The outer wall 15 of the light output protrusion 13 protrudes out from the side of the body 10 on which the light output protrusion 13 is formed and has an inclined angle between the side of the body 10.

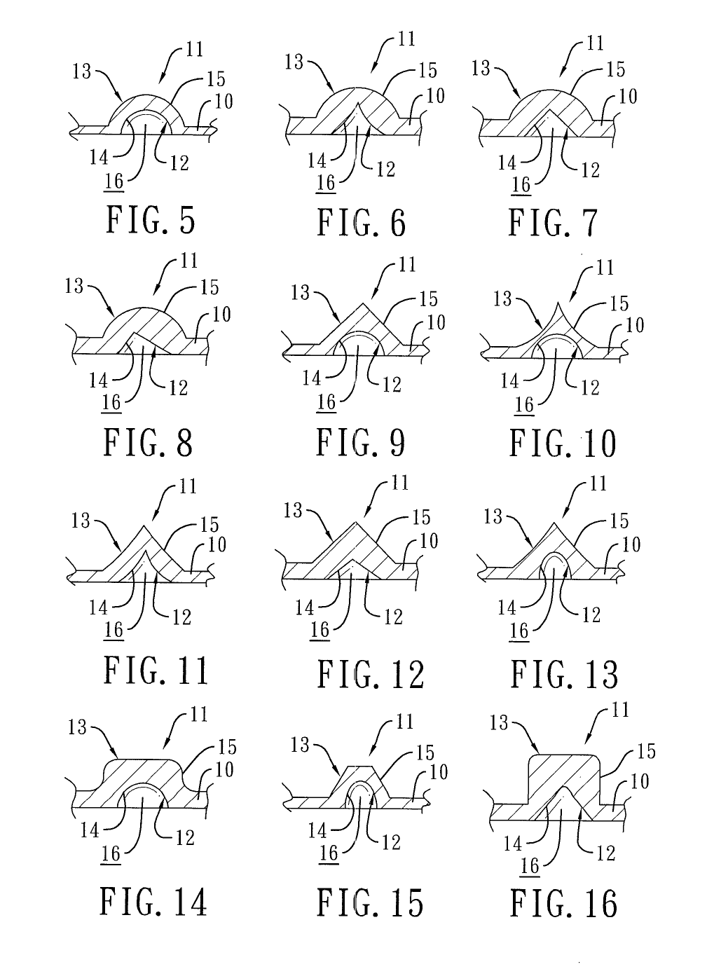

With reference to FIG. 5, the outer wall 15 of the light output protrusion 13 of each light-concentrating unit 11 is a convex surface, and the inner wall 14 of the light input recess 12 of each light-concentrating unit 11 is a concave surface.

With reference to FIG. 6, the outer wall 15 of the light output protrusion 13 of each light-concentrating unit 11 is a convex surface, and the inner wall 14 of the light input recess 12 of each light-concentrating unit 11 is composed of two convex surfaces.

With reference to FIG. 7, the outer wall 15 of the light output protrusion 13 of each light-concentrating unit 11 is a convex surface, and the inner wall 14 of the light input recess 12 of each light-concentrating unit 11 is composed of two inclined surfaces that are symmetrical to each other.

With reference to FIG. 8, the outer wall 15 of the light output protrusion 13 of each light-concentrating unit 11 is a convex surface, and the inner wall 14 of the light input recess 12 of each light-concentrating unit 11 is composed of two inclined surfaces that are not symmetrical to each other.

With reference to FIG. 9, the outer wall 15 of the light output protrusion 13 of each light-concentrating unit 11 is composed of two inclined surfaces that are symmetrical to each other, and the inner wall 14 of the light input recess 12 of each light-concentrating unit 11 is a concave surface.

With reference to FIG. 10, the outer wall 15 of the light output protrusion 13 of each light-concentrating unit 11 is composed of two concave surfaces that are symmetrical to each other, and the inner wall 14 of the light input recess 12 of each light-concentrating unit 11 is a concave surface.

With reference to FIG. 11, the outer wall 15 of the light output protrusion 13 of each light-concentrating unit 11 is composed of multiple surfaces having multiple curvatures for light input. In this embodiment, the outer wall 15 may be composed of an inclined flat surface and a concave surface. The inner wall 14 of the light input recess 12 of each light-concentrating unit 11 is composed of two convex surfaces that are symmetrical or not symmetrical to each other.

With reference to FIG. 12, the outer wall 15 of the light output protrusion 13 of each light-concentrating unit 11 is composed of two inclined surfaces that have different inclinations relative to the side of the body, and the inner wall 14 of the light input recess 12 of each light-concentrating unit 11 is composed of two inclined surfaces that have different inclinations relative to the side of the body.

With reference to FIG. 13, the outer wall 15 of the light output protrusion 13 of each light-concentrating unit 11 is composed of two concave surfaces, and the inner wall 14 of the light input recess 12 of each light-concentrating unit 11 is an ellipsoid surface.

With reference to FIG. 14, the outer wall 15 of the light output protrusion 13 of each light-concentrating unit 11 is composed of multiple surfaces having multiple curvatures for light input. In this embodiment, the outer wall 15 may be composed of a flat top surface that is parallel with the side of the body 10 and two vertical side surfaces that are perpendicular to the flat top surface. The corners between the flat top surface and the vertical sides are chamfered. The inner wall 14 of the light input recess 12 of each light-concentrating unit 11 is a concave surface.

With reference to FIG. 15, the outer wall 15 of the light output protrusion 13 of each light-concentrating unit 11 is composed of multiple surfaces having multiple curvatures for light input. In this embodiment, the outer wall 15 may be composed of a flat top surface that is parallel with the side of the body 10 and two inclined side surfaces that are inclinedly connected to the flat top surface. The inner wall 14 of the light input recess 12 of each light-concentrating unit 11 is an ellipsoid surface.

With reference to FIG. 16, the outer wall 15 of the light output protrusion 13 of each light-concentrating unit 11 is composed of multiple surfaces having multiple curvatures for light input. In this embodiment, the outer wall 15 may be composed of a flat top surface that is parallel with the side of the body 10 and two vertical side surfaces that are perpendicular to the flat top surface. The corners between the flat top surface and the vertical sides are chamfered. The inner wall 14 of the light input recess 12 of each light-concentrating unit 11 is composed of two inclined surfaces.

Alternatively, the inner wall 14 of the light input recess 12 of each light-concentrating unit 11 may be composed of multiple surfaces having multiple curvatures for light input.

In use, the lampshade is mounted on a base of an LED lamp and is mounted around the LED module of the LED lamp. The LED elements of the LED lamp are mounted in the holding spaces 16 of the light-concentrating units 11. Consequently, the light emitting from the LED elements will pass through and be refracted by the inner walls 14 of the light input recesses 12 and the outer walls 15 of the light output protrusions 13. With the curvatures of the inner walls 14 of the light input recesses 12 and the outer walls 15 of the light output protrusions 13, the way of the light can be adjusted and concentrated. Accordingly, the illumination of the light emitted from the LED lamp and passing through the lampshade in accordance with the present invention can be improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lampshade for an LED lamp comprising:
a body having two sides;
multiple light-concentrating units formed on the body, and each light-concentrating unit comprising
a light input recess defined in one of the side of the body and having an inner wall to define a holding space in the light input recess; and
a light output protrusion formed on and protruding from the other side of the body, corresponding to the light input recess and having a smooth outer wall.

2. The lampshade as claimed in claim 1, wherein the inner wall of the light input recess of each light-concentrating unit has at least one curvature for light input; and
the outer wall of the light output protrusion of each light-concentrating unit has at least one curvature for light output.

3. The lampshade as claimed in claim 1, wherein the outer wall of the light output protrusion of each light-concentrating unit is a convex surface.

4. The lampshade as claimed in claim 3, wherein the inner wall of the light input recess of each light-concentrating unit is a concave surface.

5. The lampshade as claimed in claim 3, wherein the inner wall of the light input recess of each light-concentrating unit is composed of multiple surfaces having multiple curvatures for light input.

6. The lampshade as claimed in claim 1, wherein the outer wall of the light output protrusion of each light-concentrating unit is composed of multiple surfaces having multiple curvatures for light output.

7. The lampshade as claimed in claim 6, wherein the inner wall of the light input recess of each light-concentrating unit is a concave surface.

8. The lampshade as claimed in claim 6, wherein the inner wall of the light input recess of each light-concentrating unit is composed of multiple surfaces having multiple curvatures for light input.

9. The lampshade as claimed in claim 2, wherein the outer wall of the light output protrusion of each light-concentrating unit is a convex surface.

10. The lampshade as claimed in claim 9, wherein the inner wall of the light input recess of each light-concentrating unit is a concave surface.

11. The lampshade as claimed in claim 9, wherein the inner wall of the light input recess of each light-concentrating unit is composed of multiple surfaces having multiple curvatures for light input.

12. The lampshade as claimed in claim 2, wherein the outer wall of the light output protrusion of each light-concentrating unit is composed of multiple surfaces having multiple curvatures for light output.

13. The lampshade as claimed in claim 12, wherein the inner wall of the light input recess of each light-concentrating unit is a concave surface.

14. The lampshade as claimed in claim 12, wherein the inner wall of the light input recess of each light-concentrating unit is composed of multiple surfaces having multiple curvatures for light input.

15. The lampshade as claimed in claim 1, wherein the inner wall of the light input recess of each light-concentrating unit is a concave surface.

16. The lampshade as claimed in claim 2, wherein the inner wall of the light input recess of each light-concentrating unit is a concave surface.

17. The lampshade as claimed in claim 1, wherein the inner wall of the light input recess of each light-concentrating unit is composed of multiple surfaces having multiple curvatures for light input.

18. The lampshade as claimed in claim 2, wherein the inner wall of the light input recess of each light-concentrating unit is composed of multiple surfaces having multiple curvatures for light input.
